(19) United States
(12) Patent Application Publication
(10) Pub. No.: US 2024/0269872 A1
(43) Pub. Date: Aug. 15, 2024

(54) BREAD KNIFE

(71) Applicants: Patrick Yeh, New Taipei City (TW); Tzu-Shuo Yeh, New Taipei City (TW)

(72) Inventors: Patrick Yeh, New Taipei City (TW); Tzu-Shuo Yeh, New Taipei City (TW)

(21) Appl. No.: 18/169,845

(22) Filed: Feb. 15, 2023

(51) Int. Cl. B26B 5/00; A21C 11/12; B26B 9/00

(52) U.S. Cl. CPC B26B 5/00; A21C 11/12; B26B 9/00

(57) ABSTRACT

The invention provides a bread knife including a blade and a handle. The blade has a slot and two edge portions. The slot is formed through the upper and lower sides of the blade. The two edge portions are located on two opposite sides of the slot. The knife handle is detachably disposed in the blade, and the knife handle has a holding portion, a supporting portion and a hook portion. The holding portion has a first end and a second end opposite to the first end. The supporting portion is connected to the second end of the holding portion and passes through the slot. The hook portion is disposed at an end of the supporting portion away from the holding portion and is engaged with the slot. The hook portion is located in the slot. The supporting portion passes through the slot to bend the blade into an arc.

### BACKGROUND

### Technical Field

The invention relates to a bread knife, and particularly relates to bread knife with a removable blade.

### Description of Related Art

When making bread, the chef will use bread knives to mark cracks on the surface of the dough. When the dough is baked in the oven, the gas in the dough will escape from the cracks. After baking, the dough will expand and crack to form patterns. Therefore, the bread knife directly affects the carving quality and operation safety of the baker.

The conventional long bread knife with wooden handle is penetrated the hole of the blade by the metal plate, and use the friction force between the metal plate and the hole of the blade to form an are for fixing the blade on the metal plate. In addition, the front end of the metal plate must protrude from the blade to prevent the blade from detaching the metal plate.

However, the metal piece extending outside the blade will become an obstacle when scoring the crack on the dough, so that the cutting depth of the blade is insufficient.

### SUMMARY

The invention provides a bread knife with a detachable blade, the end of the handle is located within the range of the blade, which can avoid obstruction when cutting dough. Compared with the conventional long bread knife with wooden handle, the bread knife of the invention can improve practicability and safety.

A bread knife includes a blade and a knife handle. The blade has a slot and two long edge portions. The slot is formed through the upper and lower surfaces of the blade, and the two long edge portions are located on two opposite sides of the slot. The knife handle is detachably disposed on the blade and the knife handle has a holding portion, a supporting portion, and a hook portion. The holding portion has a first end and a second end opposite to the first end. The supporting portion is connected to the second end of the holding portion and is disposed through the slot. The hook portion is disposed on an end of the supporting portion away from the holding portion and engaged with the slot. The supporting portion passes through the slot to bend the blade into an arc.

In an embodiment of the invention, the slot has a first hole, four second holes and two third holes, the first hole is located at a center of the slot, the second holes are respectively located on two sides of the first hole, and the two third holes are respectively located between the corresponding two second holes.

In an embodiment of the invention, the supporting portion is extended linearly from the second end of the holding portion, and the supporting portion is spaced apart from a center of the blade.

In an embodiment of the invention, the supporting portion is passed through the two third holes, and the hook portion is engaged with the corresponding second hole.

In an embodiment of the invention, a distance is formed between an end of the blade away from the hook portion and the supporting portion.

In an embodiment of the invention, the supporting portion is extended curvedly from the second end of the holding portion and is partially attached to the blade.

In an embodiment of the invention, the supporting portion is passed through the two third holes, and the hook portion is engaged with the corresponding second hole.

In an embodiment of the invention, a distance is formed between an end of the blade away from the hook portion and the supporting portion.

In an embodiment of the invention, the supporting portion is passed through one of the third hole and the first hole, and the hook portion is engaged with one of the second holes adjacent to the first hole.

In an embodiment of the invention, a cross-section of the supporting port is flat oval.

In an embodiment of the invention, the holding portion is a hollow structure.

In an embodiment of the invention, the blade has two grasping portions located on front and rear sides of the slot perpendicular to the two long edge portions.

Based on the above, the bread knife of the present invention adopts a detachable blade and handle, so that the end of the handle is located within the range of the blade, thereby increasing the usable range and cutting depth of the blade, and also preventing the end of the handle from touching the dough when cutting the dough. In addition, the knife handle is engaged with the blade by the hook portion, which can improve the stability of the connection between the handle and the blade, and prevent the blade from shaking during the process of cutting the dough.

Furthermore, the connection position between the blade and the knife handle can be adjusted to change the curvature of the blade, so as to meet the cutting needs of different bakers.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic plan view of a bread knife according to an embodiment of the present invention.

FIG. 2 is a partially enlarged side view schematic diagram of the bread knife of FIG. 1.

FIG. 3 is a partially enlarged schematic bottom view of the bread knife of FIG. 1.

FIG. 4 is a partially enlarged schematic top view of the bread knife of FIG. 1.

FIG. 5 is a schematic plan view of a bread knife according to another embodiment of the present invention.

FIG. 6 is a partially enlarged schematic side view of the bread knife of FIG. 5.

FIG. 7 is a partially enlarged schematic bottom view of the bread knife of FIG. 5.

FIG. 8 is a partially enlarged schematic top view of the bread knife of FIG. 5.

FIG. 9 is a partially enlarged schematic side view of adjusting the position of the blade of the bread knife of FIG. 5.

FIG. 10 is a schematic bottom view of the bread knife in FIG. 9.

### DESCRIPTION OF THE EMBODIMENTS

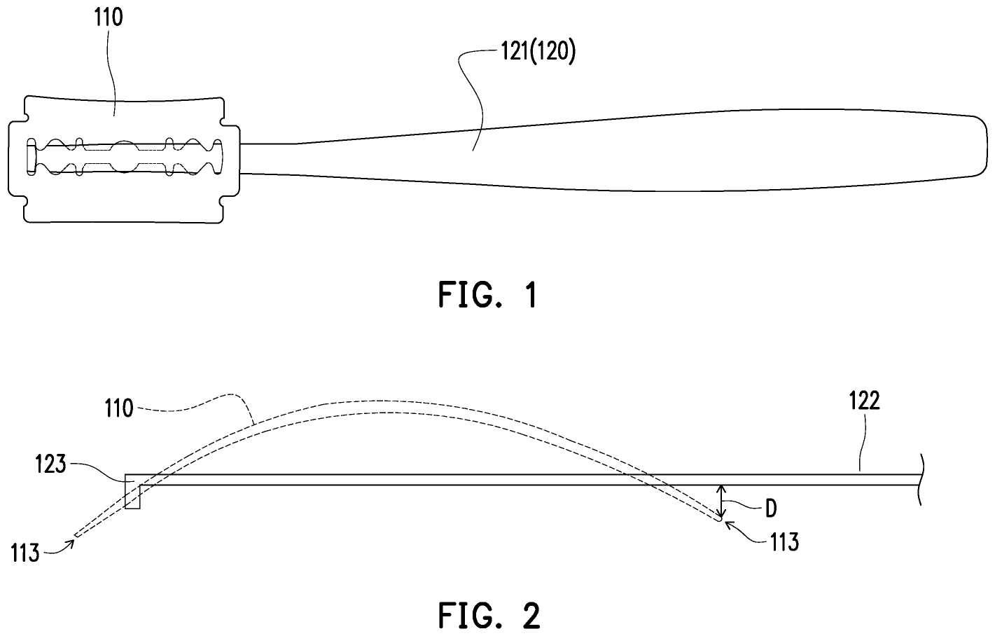

Referring to FIG. 1, the bread knife 100 of the present invention is used to cut patterns on the dough for users, and the dough will produce special patterns after being baked to improve the texture of the bread.

Referring to FIGS. 1 and 2, the bread knife 100 includes a blade 110 and a knife handle 120.

The blade 110 has a slot 111, two long edge portions 112, and two grasping portions 113. The slot 111 is formed through the upper and lower sides of the blade 110. The two long edge portions 112 are located on two opposite sides S1 of the slot 111, and the two grasping portions 113 are located on the front and rear sides S2 of the slot 111 perpendicular to the two long edge portions 112. Further, each of the long edge portions 112 and each of the grasping portions 113 are straight line shapes. In other embodiments, each of the long edge portions 112 and each of the grasping portions 113 may also adopt an are shape.

The knife handle 120 is detachably disposed in the blade 110, and the knife handle 120 has a holding portion 121, a supporting portion 122, and a hook portion 123. The holding portion 121 has a first end E1 and a second end E2 opposite to the first end E1. The supporting portion 122 is connected to the second end E2 of the holding portion 121 and passes through the slot 111. The hook portion 123 is disposed at an end of the supporting portion 122 away from the holding portion 121 and engaged with the slot 111. The supporting portion 122 passes through the slot 111 to bend the blade 110 into an arc.

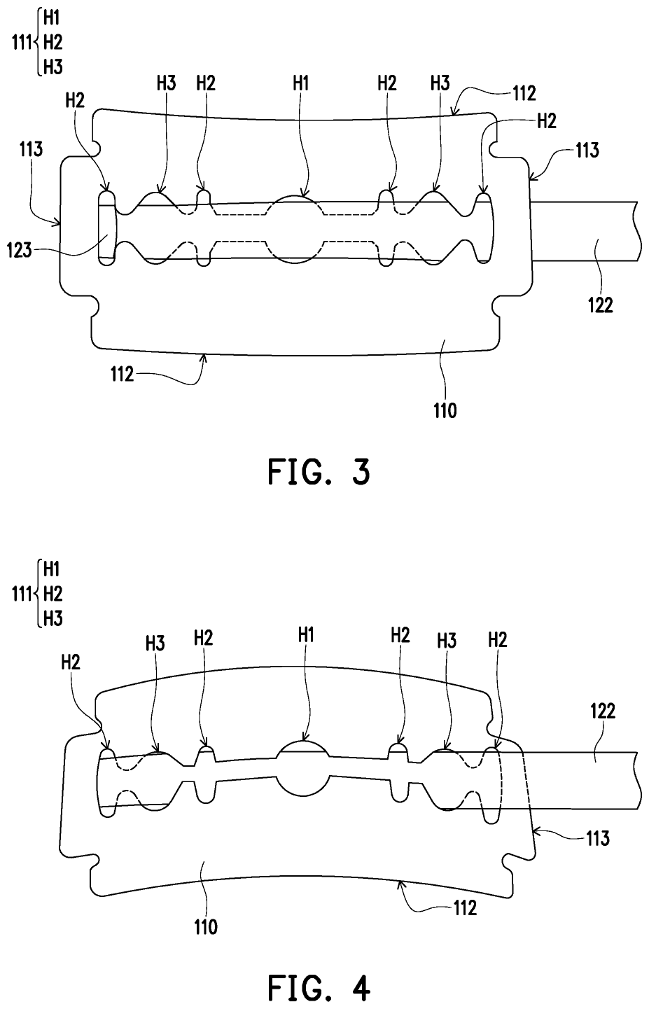

Referring to FIGS. 3 and 4, the slot 111 of the blade 110 includes a first hole H1, four second holes H2, and two third holes H3. The first hole H1 is located at a center of the slot 111. The four second holes H2 are located at two sides of the slot 111. The two third holes H3 are respectively located between the corresponding two second holes H2. Furthermore, the supporting portion 122 is adapted to penetrate the first hole H1, the second hole H2 or the third hole H3 of the slot 111.

Referring to FIGS. 2 to 4, the supporting portion 122 is extended linearly from the second end E2 of the holding portion 121, the supporting portion 122 is passed through two third holes H3, and the hook portion 123 engages in the second hole H2 away from the holding portion 121. The blade 110 is bent by the supporting portion 122 into are shape and the supporting portion 122 is spaced apart from a center of the blade 110.

In detail, when the user grasps the two grasping portions 113 of the blade 110 with the index finger and the thumb and applies pressure at the same time, after the blade 110 is bent, the supporting portion 122 of the knife handle 120 is passed through the two third holes H3, and then the hook portion 123 is engaged with the second hole H2 at the front end of the blade 110, and finally relaxing the force applied by the index finger and thumb to allow the blade 110 to recover elastically, so that the two third holes H3 and the supporting portion 122 are engaged with each other. The blade 110 is limited by the supporting portion 122 and formed are shape. The hook portion 123 is tightly engaged with the second hole H2 of the blade 110 to ensure that the blade 110 is fixed on the supporting portion 122.

Referring to FIG. 2, a distance D is formed between an end of the blade 110 away from the hook portion 123 and the supporting portion 122. In detail, if the blade 110 is to be removed, the user applies forces to the two grasping portions 113 of the blade 110 with the index finger and the thumb, so that the hook portion 123 is detached from the second hole H2 at the front end of the blade 110, and then the supporting portion 122 is pulled out from the two third holes H3 of the blade 110.

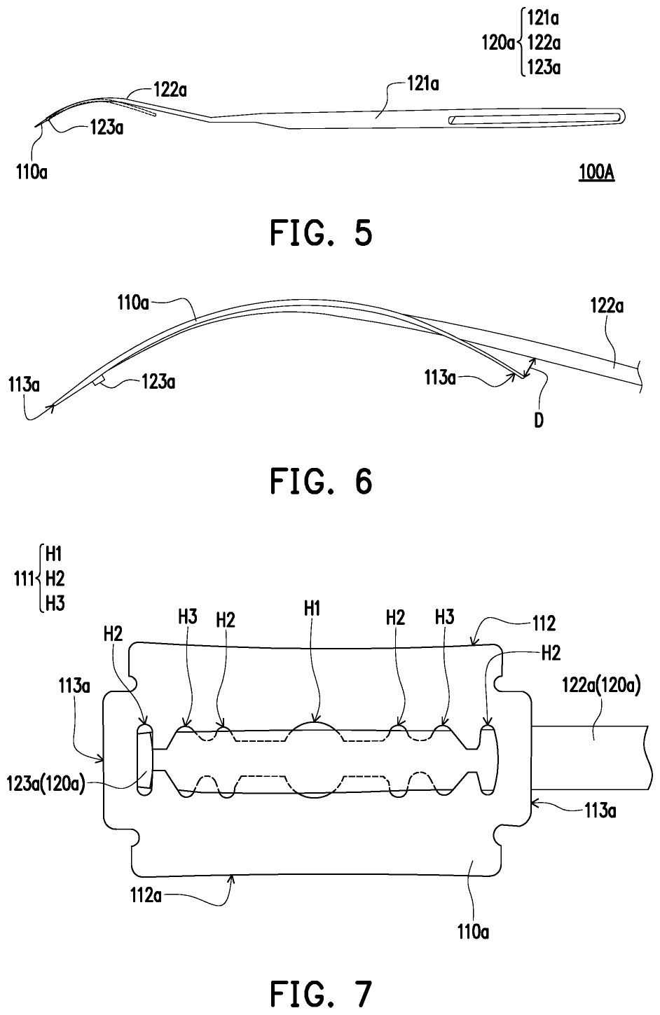

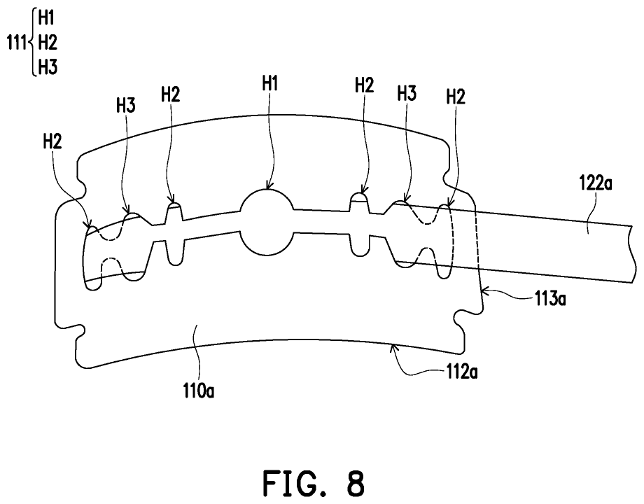

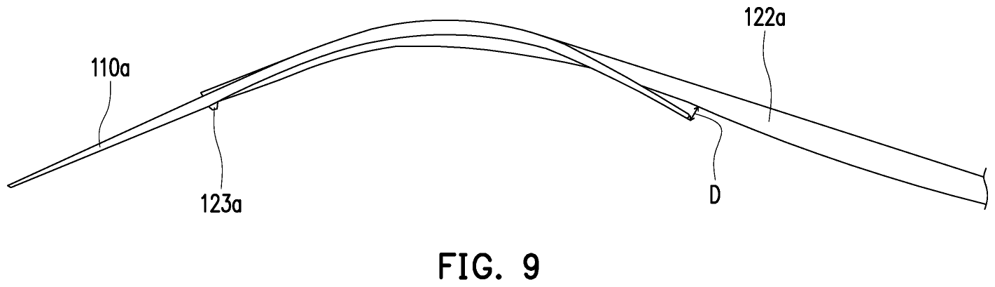

Referring to FIGS. 5 to 8, the bread knife 100A of this embodiment is different from the bread knife 100 shown in FIG. 1. The supporting portion 122a is extended curvedly from the second end E2 of the holding portion 121a, the supporting portion 122a is passed through the two third holes H3, and the hook portion 123a is engaged with the second hole H2 away from the holding portion 121a, then the blade 110a is bent by the supporting portion 122 into are shape and the supporting portion 122a is partially attached to the blade 110a. Furthermore, since the support portion 122a is arc-shaped and partially attached to the blade 110a, the resistance generated from scoring the dough can be reduced.

In detail, when the user grasps the two grasping portions 113a of the blade 110a with the index finger and the thumb and applies pressures at the same time, after the blade 110 is bent, the supporting portion 122a of the knife handle 120a is passed through the two third holes H3, and then the hook portion 123a is engaged with the second hole H2 at the front end of the blade 110a, and finally relaxing the forces exerted by the index finger and thumb to allow the blade 110a to recover elastically. So that the two third holes H3 and the supporting portion 122a are engaged with each other, allowing the blade 110 is bent along the supporting portion 122a and formed are shape. The hook portion 123a is tightly engaged with the second hole H2 of the blade 110a to ensure that the blade 110a is fixed on the support portion 122a.

Referring to FIG. 2, a distance D between the end of the blade 110a away from the hook portion 123a and the supporting portion 122a. In detail, if the blade 110a is to be removed, the user applies force to the two grasping portions 113a of the blade 110a with the index finger and the thumb, so that the hook portion 123a is detached from the second hole H2 at the front end of the blade 110a, and then the support portion 122a is pulled out from two third holes H3 of the blade 110a.

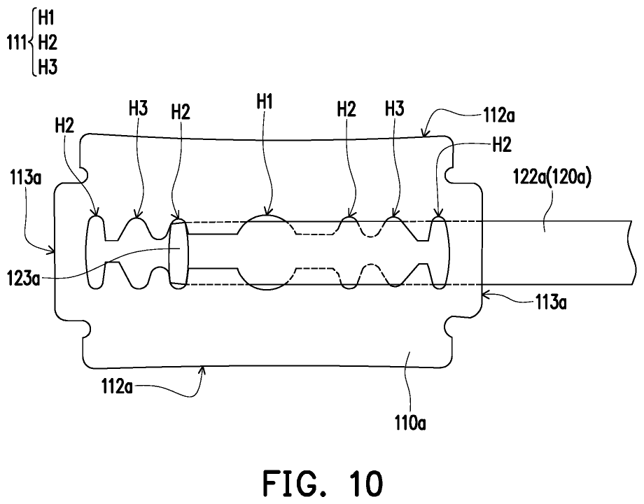

Referring to FIGS. 9 and 10, the supporting portion 122a is extended curvedly from the second end E2 of the holding portion 121a, the supporting portion 122a is passed through one of the third hole H3 and the first hole H1, and the hook portion 123a is engaged with one of the second holes H2 adjacent to the first hole H1. The blade 110a is bent into are shape by the supporting portion 122a, and the supporting portion 122a is partially attached to the blade 110a. In this embodiment, the end of the blade 110a is relatively far away from the hook portion 123a, so that the blade 110a has different softness and the blade 110a has a longer unbent long edge portions 112a and a low-resistance blade use range, so as to change the tactile sensation when scoring dough.

Referring to FIG. 5, the thickness of the supporting portion 122a is smaller than the thickness of the holding portion 121a and a cross-section of the supporting portion 122a is flat oval. Further, since the cross-section of the support portion 122a is flat oval, which matched the shapes of the first hole, the second hole and the third hole of the blade 110a, so that the supporting portion 122a is closer to the blade 110a, thereby enlarging the effective cutting range of the blade 110a.

In another embodiment, the holding portion is a hollow structure, and the holding portion is made of hollow stainless steel, so as to reduce the weight of the holding portion.

In another embodiments, the radian of the supporting portion is adjusted, so as to change the radian of the blade 110a installed on the supporting portion, so as to meet the needs of different users for the radian of the blade.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A bread knife comprising:
a blade having a slot and two long edge portions, wherein, the slot is formed through the upper and lower surfaces of the blade, and the two long edge portions are located on two opposite sides of the slot; and
a knife handle is detachably disposed on the blade, and the knife handle has:
a holding portion having a first end and a second end opposite to the first end;
a supporting portion, connected to the second end of the holding portion and disposed through the slot; and
a hook portion, disposed on an end of the supporting portion away from the holding portion and engaged with the slot,
Wherein, the hook portion is located in the slot, and the supporting portion passes through the slot to bend the blade into an arc.

2. The bread knife according to claim 1, wherein the slot has a first hole, four second holes and two third holes, the first hole is located at a center of the slot, the second holes are respectively located on two sides of the first hole, and the two third holes are respectively located between the corresponding two second holes.

3. The bread knife according to claim 2, wherein the supporting portion is extended linearly from the second end of the holding portion, and the supporting portion is spaced apart from a center of the blade.

4. The bread knife according to claim 3, wherein the supporting portion is passed through the two third holes, and the hook portion is engaged with the corresponding second hole.

5. The bread knife according to claim 3, wherein a distance is formed between an end of the blade away from the hook portion and the supporting portion.

6. The bread knife according to claim 2, wherein the supporting portion is extended curvedly from the second end of the holding portion and is partially attached to the blade.

7. The bread knife according to claim 6, wherein the supporting portion is passed through the two third holes, and the hook portion is engaged with the corresponding second hole.

8. The bread knife according to claim 6, wherein a distance is formed between an end of the blade away from the hook portion and the supporting portion.

9. The bread knife according to claim 6, wherein the supporting portion is passed through one of the third hole and the first hole, and the hook portion is engaged with one of the second holes adjacent to the first hole.

10. The bread knife according to claim 1, wherein a cross-section of the supporting port is flat oval.

11. The bread knife according to claim 1, wherein the holding portion is a hollow structure.

12. The bread knife according to claim 1, wherein the blade has two grasping portions located on front and rear sides of the slot perpendicular to the two long edge portions.
